(19) United States
(12) Patent Application Publication
(10) Pub. No.: US 2015/0160896 A1
(43) Pub. Date: Jun. 11, 2015

(54) PRINT MANAGEMENT AND MONITORING METHOD

(71) Applicant: ARC Document Solutions, Inc., Walnut Creek, CA (US)

(72) Inventors: Rahul ROY, Fremont, CA (US); Chaitanya GARLAPATI, Fremont, CA (US); Satyasudhakar MUKKAMALA, Fremont, CA (US); Srikant SHARMA, Kolkata (IN)

(21) Appl. No.: 14/562,168

(22) Filed: Dec. 5, 2014

Related U.S. Application Data
(60) Provisional application No. 61/912,522, filed on Dec. 5, 2013.

(51) Int. Cl. G06F 3/12

(52) U.S. Cl. CPC G06F 3/1204; G06F 3/1232; G06F 3/1273

(57) ABSTRACT

Systems and methods for managing and monitoring a print are disclosed. An electronic document is received for a print job via a computer network. After receiving the electronic document, a plurality of characteristics for the print job is determined. Based on the plurality of characteristics, one or more conditions of one or more network-connected printers are detected by monitoring the one or more network-connected printers. Further, a recommendation is generated to utilize the one of the printers based on the one or more conditions and plurality of characteristics for the print job. Subsequently, one of the printers is selected based on the recommendation. After selecting the printer, the print job is transmitted for printing the electronic document.

### REFERENCE TO RELATED APPLICATIONS

The application claims benefit of priority to U.S. Provisional Patent Application No. 61/912,522, filed with the United States Patent and Trademark Office on Dec. 5, 2013, entitled “AUTO MANAGED PRINT STORAGE,” the entirety of which is hereby incorporated by reference.

### FIELD OF INVENTION

The present disclosure in general relates to a print and archival of electronic documents. More particularly, the present disclosure relates to a system(s) and method(s) for managing and monitoring a print.

### BACKGROUND

Organizations may comprise a computer network that includes many individual computers and a plurality of printers connected over a network. Typically, type of printers available on the network may vary and each printer may have its own characteristics. For example, a printer may be capable of printing black texture on a sheet. If a user wishes to print a document that comprises colours, the printer capable of printing black texture may not be an appropriate printer. Further, location of the printer to print documents may be important. If the user wishes to print the document at a desired location, the user may have to identify a printer available in the desired location and capability of printer to print the document in a desired manner.

Managing the printers connected over the network is a tedious and time consuming task. When a plurality of computing devices is connected to the plurality of printers, each computing device may individually or simultaneously transmit print job/requests to a printer. Generally, a print manager may be used to manage the print job. The print manager may manage the print job by sending the documents to the printer selected by the user. The print manager may send the documents without having knowledge of a status of the printer. Sending the documents to a printer without knowing the status may have difficulties. For example, consider the user wish to print a document using various colours. At the time of selecting the printer, if the user selects a printer capable of printing black texture, the user may not obtain the document as required.

Often, the organizations store the documents in physical format which involves huge investment in managing an inventory of the documents. Storing the documents in the physical format may not be feasible. Because if the user wish to retrieve the documents, it may be difficult to identify the documents. Further, storing the documents physically may lead to data loss and may not be secure.

With developments in technology and document archival system, the organizations may store the electronic documents in a digital format in a database. With increase in size of the electronic documents and various formats of the electronic documents, it may be difficult to identify and retrieve the electronic documents from the database. For example, when the electronic documents are stored in a picture format upon scanning the physical document, it may be difficult to identify the electronic document and retrieve from the database. Current document archival systems do not provide efficient document storage capabilities and can be costly.

### SUMMARY

This summary is provided to introduce concepts related to systems and methods for managing and monitoring a print and the concepts are further described below in the detailed description. This summary is not intended to identify essential features of the claimed subject matter nor is it intended for use in determining or limiting the scope of the claimed subject matter.

A method for managing and monitoring a print is disclosed. The method comprises receiving, by a processor, an electronic document for a print job. The electronic document is received via a computer network. The method further comprises determining, by the processor, a plurality of characteristics for the print job. The method further comprises detecting, by the processor, one or more conditions of one or more network-connected printers. The one or more conditions are detected by monitoring the one or more network-connected printers. The method further comprises generating, by the processor, a recommendation to utilize one of the printers based on the detected conditions of the network-connected printers and the plurality of characteristics for the print job. The method further comprises selecting, by the processor, one of the printers based on the recommendation. The method further comprises transmitting, by the processor, the print job for printing the electronic document to the printer selected. The method further comprises archiving the electronic document in a database.

A system for managing and monitoring a print is disclosed. The system comprises a processor and a memory coupled to the processor. The processor is capable of executing program instructions stored in the memory. The processor executes the program instructions to receive an electronic document for a print job. The electronic document is received via a computer network. The processor further executes the program instructions to determine a plurality of characteristics for the print job. The processor further executes the program instructions to detect one or more conditions of one or more network-connected printers. The one or more conditions are detected by monitoring the one or more network-connected printers. The processor further executes the program instructions to generate a recommendation to utilize one of the printers based on the detected conditions of the network-connected printers and the plurality of characteristics for the print job. The processor further executes the program instructions to select one of the printers based on the recommendation. The processor further executes the program instructions to transmit the print job for printing the electronic document to the printer selected.

A non-transitory computer readable medium embodying a program executable in a computing device for managing and monitoring a print is disclosed. The program comprises a program code for receiving an electronic document for a print job. The electronic document is received via a computer network. The program further comprises a program code for determining a plurality of characteristics for the print job. The program further comprises a program code for detecting one or more conditions of one or more network-connected printers. The one or more conditions are detected by monitoring the one or more network-connected printers. The program further comprises a program code for generating a recommendation to utilize one of the printers based on the detected conditions of the network-connected printers and the plurality of characteristics for the print job. The program further comprises a program code for selecting one of the printers based on the recommendation. The program further comprises a program code for transmitting the print job for printing the electronic document to the printer selected.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to refer like/similar features and components.

FIG. 1 illustrates a network implementation of a system for managing and monitoring a print, in accordance with an embodiment of the present disclosure.

FIG. 2 illustrates the system, in accordance with an embodiment of the present disclosure.

FIG. 3 illustrates a method facilitating integration among modules of the system, in accordance with an embodiment of the present disclosure.

FIG. 4 illustrates a method for archiving the print, in accordance with an embodiment of the present disclosure.

FIG. 5 illustrates a method for managing and monitoring a print, in accordance with an embodiment of the present disclosure

### DETAILED DESCRIPTION

System(s) and method(s) for managing and monitoring a print are disclosed. At first, an electronic document may be received via a computer network. The electronic document may be received for a print job. After receiving the electronic document, a plurality of characteristics for the print job may be determined. Based on the plurality of characteristics, one or more conditions of one or more network-connected printers may be detected. The one or more conditions may be detected by monitoring the one or more network-connected printers.

Based on the one or more conditions and plurality of characteristics for the print job, a recommendation may be generated to utilize one of the printers. Subsequently, one of the printers may be selected based on the recommendation. After selecting the printer, the print job may be transmitted for printing the electronic document. While the print job is managed and transmitted for printing, the electronic documents may be archived in a database.

While aspects of described system and method for managing and monitoring a print may be implemented in any number of different computing systems, environments, and/or configurations, the embodiments are described in the context of the following exemplary system.

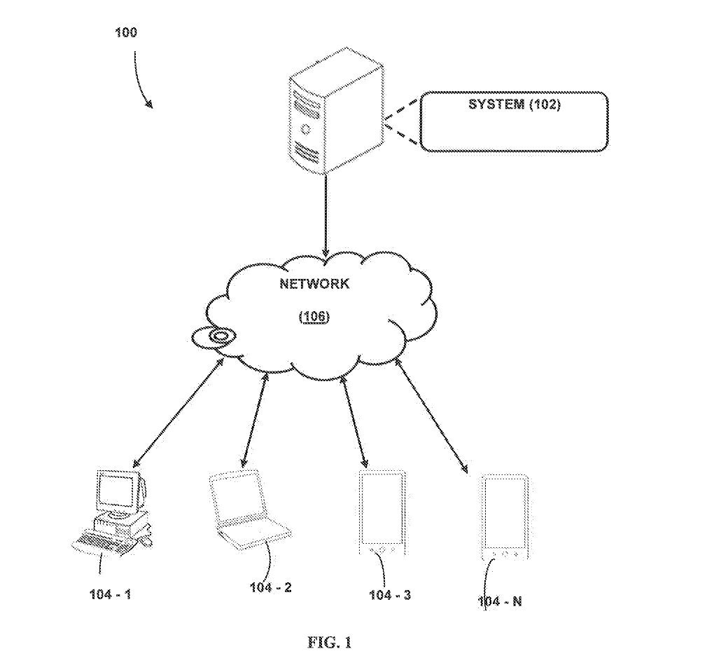

Referring now to FIG. 1, a network implementation 100 of a system 102 for managing and monitoring a print is illustrated, in accordance with an embodiment of the present disclosure. The system 102 may receive an electronic document for a print job via a computer network. The system 102 may determine a plurality of characteristics for the print job. Further, the system 102 may detect one or more conditions of one or more network-connected printers. The system 102 may detect the one or more conditions by monitoring the one or more network-connected printers. The system 102 may generate a recommendation to utilize one of the printers based on the conditions of the network-connected printers and the plurality of characteristics for the print job. The system 102 may select one of the printers based on the recommendation. Subsequently, the system 102 may transmit the print job for printing the electronic document to the printer selected.

Although the present disclosure is explained by considering a scenario that the system 102 is implemented as an application on a server. It may be understood that the system 102 may also be implemented in a variety of computing systems, such as a laptop computer, a desktop computer, a notebook, a workstation, a mainframe computer, a server, a network server, and the like. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

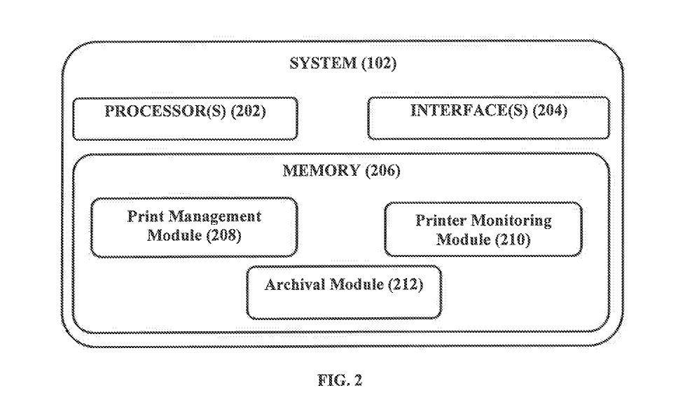

Referring now to FIG. 2, the system 102 is illustrated in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules such as a print management module 210, a printer monitoring module 210 and an archiving module 212. The print management module 210, the printer monitoring module 210 and the archiving module 212 may include routines, programs, objects, components, data structures, etc., which perform particular tasks or implement particular abstract data types.

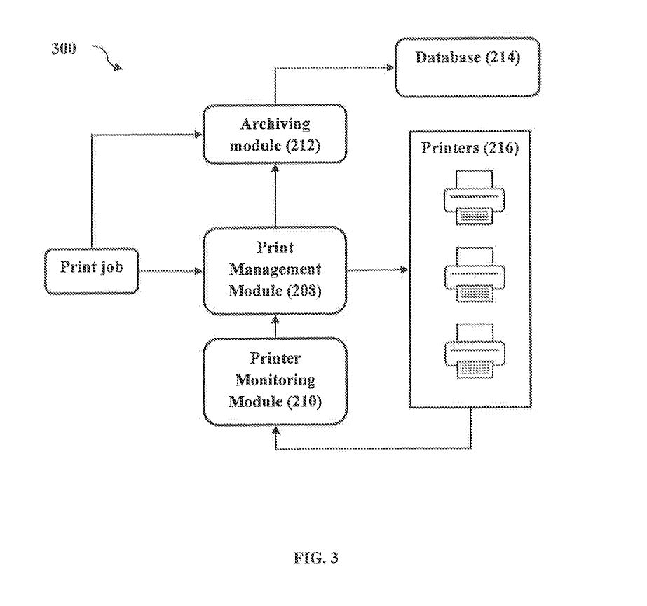

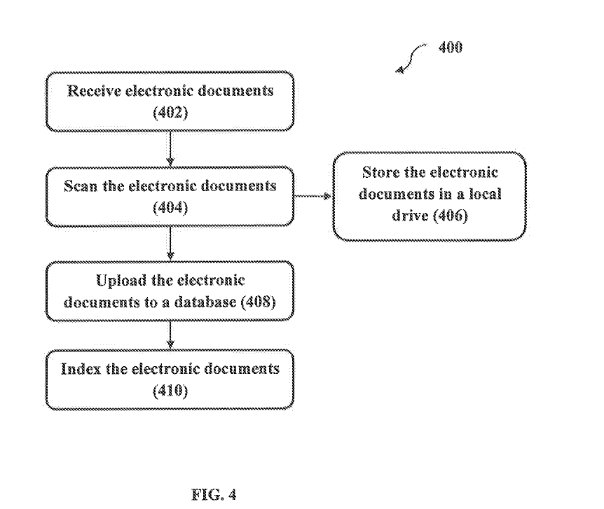

In one implementation, at first, a user may use the client device 104 to access the system 102 via the I/O interface 204. The working of the system 102 may be explained in detail using FIG. 2, FIG. 3 and FIG. 4 explained below. The system 102 may be used for managing and monitoring a print. In order manage the print; the system 102 may receive an electronic document for a print job. Specifically, the system 102 may employ the print management module 208 to receive the electronic document. The print job may indicate a file or set of files that may be submitted for printing. Each print job may be identified by a unique number. In one implementation, the print management module 208 may receive the electronic document from the user via the I/O interface 204. In one implementation, the print management module 208 may receive the electronic document from a computer network. In one example, the computer network may comprise at least of a portable computer, a personal digital assistant, a handheld device, an image capturing device and a workstation. In order to present the electronic document, the user may have to register him/her with the system 102. After the user is registered with the system 102, the user may be provided with security credentials to access the system 102. Subsequently, when the user tries to access the system 102, the security credentials of the user with respect to the registration may be checked.

After the credentials of the user are checked, the system 102 may present an application to the user. The application may comprise a plurality of data fields. The plurality of data fields may be presented to receive details of the print job from the user. The plurality of data fields may comprise data values associated with the data fields. In one example, the data fields may comprise at least one of electronic document details, and print characteristics of the document. In one example, the electronic documents may comprise a word document, a spreadsheet document, an image file, and a pdf file. The electronic documents may comprise other files that contain information in a certain format and use of such files is obvious to persons skilled in the art.

Referring to FIG. 3, a method 300 facilitating integration among the print management module 208, the printer monitoring module 210 and the archiving module 212 is illustrated. After receiving the electronic document, the system 102 may determine a plurality of characteristics for the print job. Specifically, the print management module 208 may determine the plurality of characteristics. The plurality of characteristics may include colours, size of the electronic document and text contour. In another example, if the electronic document contains a drawing, the system 102 may receive the characteristics such as contours of the edges, line thickness, and colours etc. In one example, the user may provide instructions and preferences to be used for the print job. For example, the instructions may include a time of printing, location of printing, etc. The preferences may include specifying a location for printing near to a location of the user.

Subsequently, the system 102 may monitor one or more network-connected printers 216. Specifically, the system 102 may employ the printer monitoring module 210 to monitor the one or more network-connected printers 216. The one or more network-connected printers 216 may be connected by a wired communication with the system 102. In one implementation, the one or more network-connected printers 216 may be distributed across various locations and may be connected over a cloud environment. After monitoring the one or more network-connected printers 216, the printer monitoring module 210 may detect one or more conditions of one or more network-connected printers 216. The one or more conditions may comprise a status of the printers, a queue status, power up status, toner and ink status, and other printer features such as number of pages available for printing at the printer, a time of use, and capability of printer to print selected colours.

After detecting the one or more conditions of the one or more network-connected printers 216, the printer monitoring module 210 may send a status indicating the conditions to the print management module 208. Based on the one or more conditions received and the plurality of characteristics for the print job, the print management module 208 may generate a recommendation to utilize one of the printers. Based on the recommendation, the system 102 may select one of the printers. In order to explain the selection of printer from the one or more network-connected printers, an example may be used. Consider the system 102 receives a print job comprising an electronic document e.g., a drawing sheet with the characteristics e.g., a large format of black drawing. The printer monitoring module 210 may monitor the one or more network-connected printers 216 to detect at least one printer having the conditions to print the large format of black drawing. In order to explain the monitoring of the printers and detect the conditions, Table 1 may be used as an example. Specifically, Table 1 shows the one or more network-connected printers 216 and the conditions of the one or more network-connected printers 216.

TABLE 1
Table 1: Printers and conditions

| | Conditions | | | |
|---|---|---|---|---|
| | | Colour/Black | | Toner and ink |
| Printer | Power on status | and white | Size | status |
| Printer 1 | ON | Colour/Black | All | Full |
| | | and white | | |
| Printer 2 | ON | Colour/Black | All | Medium |
| | | and white | | |
| Printer 3 | OFF | Black and | All | Full |
| | | white | | |
| Printer 4 | ON | Colour/Black | All | Low |
| | | and white | | |

After monitoring the one or more network-connected printers 216, the printer monitoring module 210 may provide a list of printers that comprise optimum conditions to print the large format of black drawing. In one implementation, the printer monitoring module 210 may provide the list to the print management module 208. For the above example, the printer monitoring module 210 may provide the list as shown in Table 2 to the print management module 208. After receiving the list, the print management module 208 may check for the printer having the optimum conditions to print the electronic documents based on the characteristics for the print job. For the example, the printer management module 208 may identify that the printer 1 and printer 2 to be optimum based on the conditions as shown in Table 2.

TABLE 2
Table 2: List of optimum printers

| | Conditions | | | |
|---|---|---|---|---|
| | | Colour/Black | | Toner and ink |
| Printer | Power on status | and white | Size | status |
| Printer 1 | ON | Colour/Black | All | Full |
| | | and white | | |
| Printer 2 | ON | Colour/Black | All | Medium |
| | | and white | | |

For the above example shown in Table 2, based on the conditions of the one or more network-connected printers 216, the print management module 208 may generate the recommendation to utilize the printer 1, as the printer 1 comprises the optimum conditions to print the electronic document. After selecting the printer, the print management module 208 may transmit the print job for printing the electronic document. For the above example, the print management module 208 may transmit the print job to printer 1 for printing the electronic document.

In one implementation, the print management module 208 may generate the recommendation based on proximity of the printer to the user. In order to determine the proximity, the print management module 208 may receive a status corresponding to distance of the printer 216 from the location of the print job. Specifically, the print management module 208 may receive the status from the printer monitoring module 210. After receiving the status, the print management module 208 may select the printer that may be closer to the location of the user providing the print job. After selecting the printer 216, the print management module 208 may transmit the print job to the printer for printing the electronic document.

After transmitting the print job the electronic document may be printed at the location of the printer 216 selected. At the time of printing, the management module 208 may track printing of the electronic documents and number of copies printed by the printer 216. In one implementation, after transmission of the print job, the system 102 may generate a bill comprising a cost for printing the electronic documents based on the characteristics and the conditions of the printers 216. In one implementation, the system 102 may employ a billing module (not shown) to track the number of copies printed and to generate the bill.

In one implementation, when the print job comprises two or more electronic documents, the system 102 may transmit the two or more electronic documents in a queue. Specifically, the print management module 208 may transmit the two or more electronic documents in the queue. In order to transmit the electronic documents in the queue, the print management module 208 may receive the one or more conditions of the printer 216. For example, the print management module 208 may receive the status indicating that the printer 216 selected is printing another document and the electronic document transmitted may be printed upon completion of printing another document. Based on the status received, the print management module 208 may transmit the electronic document after printing of another document. In one implementation, if two or more electronic documents are present in the print job, the user may determine an order in which the electronic documents are to be printed by the printer 216. The user may determine the order by specifying a rule for each of the electronic documents in the queue. Subsequently, when two or more electronic documents are transmitted, the electronic documents may be printed in the order determined by the user. In one implementation, the system 102 may facilitate the user to override the rule specified for the electronic document and the order determined. In order to override the rule and the order, the user may have to provide with additional security access details such as a username, password, an access card, and a biometric authentication. When the user tries to override the rule and the order, the system 102 may prompt the user to provide the additional security access details. If the user provides the additional security access details, the system 102 may allow the user to override the rule and the order.

At the time of receiving the electronic document for the print job, the electronic document and the plurality of characteristics of the electronic document may be stored. Specifically, the system 102 may employ the archiving module 212 to store the electronic document in a database 214. In one example, the database 214 may be a local drive residing in the memory 206 or an external database (not shown) over a cloud environment.

Referring to FIG. 4, a method 400 for archiving the print is illustrated. In order to archive the print, at first, the system 102 may receive a document in a physical format such a sheet, drawing, etc as shown at step/block 402. Upon receiving, the document may be scanned by the user using a scanner (not shown) as shown at step 404. Subsequently, the electronic document may be stored in the local drive as shown at step 406. Further, the electronic documents may be uploaded for storing the electronic documents in the database 214 as shown at step 408.

After the electronic documents are stored in the database 214, the system 102 may employ an Optical Character Recognition (OCR) engine (not shown) to convert the electronic documents into a pdf documents. The OCR engine may analyze text, image, or the drawings present in the electronic document for conversion. After analyzing the electronic documents, the OCR engine may create an index of the electronic documents as shown at step 410. The index may be created such that when the user performs a search to identify an electronic document, the system 102 may identify the index and retrieve the electronic document. In one implementation, the index may be stored in the memory 206 or the database 214.

If the user has to select one of the electronic documents for printing, the user may perform a search in the database 214 to identify the electronic document. Upon searching, the user may select the electronic document required for printing. After selection, the system 120 may determine the plurality of characteristics of the electronic document for the print job. Subsequently, the system 102 may detect one or more conditions of the network connected printers 216 to transmit the print job as described above.

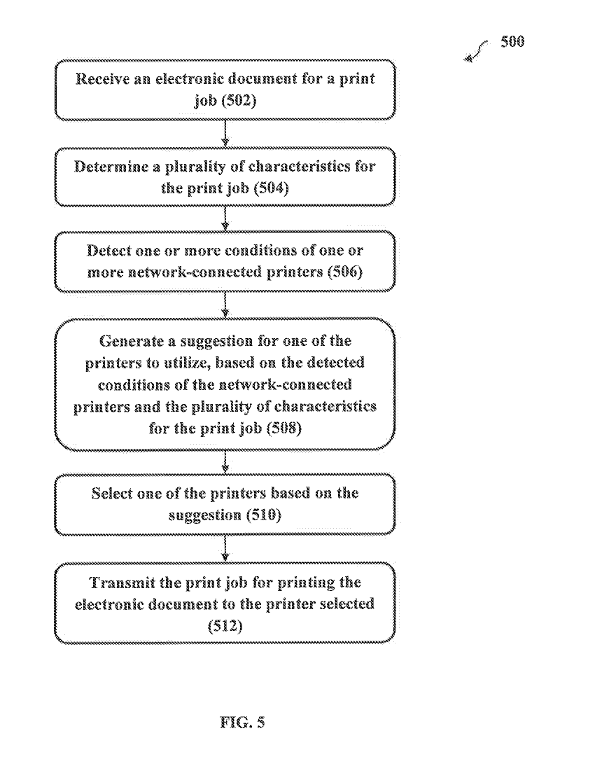

Referring now to FIG. 5, a method 500 for managing and monitoring a print is shown, in accordance with an embodiment of the present disclosure. The method 500 may be described in the general context of computer executable instructions. Generally, computer executable instructions can include routines, programs, objects, components, data structures, procedures, modules, functions, etc., that perform particular functions or implement particular abstract data types. The method 500 may also be practiced in a distributed computing environment where functions are performed by remote processing devices that are linked through a communications network. In a distributed computing environment, computer executable instructions may be located in both local and remote computer storage media, including memory storage devices.

The order in which the method 500 is described and is not intended to be construed as a limitation, and any number of the described method blocks can be combined in any order to implement the method 500 or alternate methods. Additionally, individual blocks may be deleted from the method 500 without departing from the spirit and scope of the disclosure described herein. Furthermore, the method may be implemented in any suitable hardware, software, firmware, or combination thereof. However, for ease of explanation, in the embodiments described below, the method 500 may be implemented in the above-described system 102.

At step/block 502, an electronic document for a print job may be received via a computer network.

At step/block 504, a plurality of characteristics for the print job may be determined.

At step/block 506, one or more conditions of one or more network-connected printers may be detected. The one or more conditions may be detected by monitoring the one or more network-connected printers.

At step/block 508, a recommendation may be generated to utilize one of the printers based on the detected conditions of the network-connected printers and the plurality of characteristics for the print job.

At step/block 510, one of the printers may be selected based on the recommendation.

At step/block 512, the print job may be transmitted for printing the electronic document to the printer selected.

Although implementations for methods and systems for managing and monitoring a print have been described in language specific to structural features and/or methods, it is to be understood that the appended claims are not necessarily limited to the specific features or methods described. Rather, the specific features and methods are disclosed as examples of implementations for managing and monitoring a print.

1. A method for managing and monitoring a print, comprising:
receiving, by a processor, an electronic document for a print job, wherein the electronic document is received via a computer network;
determining, by the processor, a plurality of characteristics for the print job;
detecting, by the processor, one or more conditions of one or more network-connected printers, wherein the one or more conditions are detected by monitoring the printers;
generating, by the processor, a recommendation to utilize one of the printers based on the detected conditions and the determined characteristics;
selecting, by the processor, one of the printers based on the recommendation; and
transmitting, by the processor, the print job to the selected printer for printing the electronic document.

2. The method of claim 1, further comprising tracking one or more parameters associated with each printer, wherein the one or more parameters include at least one of usage of the printer, time of usage, or number of pages printed, copied, or scanned.

3. The method of claim 1, wherein the recommendation is generated based on print characteristics of one of the printers.

4. The method of claim 3, wherein one of the printers is selected based on proximity to a user.

5. The method of claim 1, further comprising archiving the electronic document.

6. The method of claim 1, wherein the print job is transmitted in a queue to the selected printer.

7. The method of claim 1, wherein the one or more conditions of the printer include at least one of a status of a queue, a status of printer power up, and a status of a toner or ink.

8. A system for managing and monitoring a print, the system comprising:
a processor; and
a memory coupled to the processor, wherein the processor is capable of executing program instructions stored in the memory, to:
receive an electronic document for a print job, wherein the electronic document is received via a computer network;
determine a plurality of characteristics for the print job;
detect one or more conditions of one or more network-connected printers, wherein the one or more conditions are detected by monitoring the printers;
generate a recommendation to utilize one of the printers based on the detected conditions of the printers and the determined characteristics;
select one of the printers based on the recommendation; and
transmit the print job to the selected printer for printing the electronic document.

9. The system of claim 8, wherein the processor further executes the program instructions to track one or more parameters associated with each printer, wherein the one or more parameters include at least one of usage of the printer, time of usage, or number of pages printed, copied, or scanned.

10. The method of claim 8, wherein the recommendation is generated based on print characteristics of one of the printers.

11. The method of claim 10, wherein one of the printers is selected based on proximity to a user.

12. The system of claim 8, wherein the processor further executes the program instructions to archive the electronic document.

13. The system of claim 8, wherein the print job is transmitted in a queue to the select printer.

14. The system of claim 8, wherein the one or more conditions of the printer include at least one of a status of a queue, a status of printer power up, and a status of a toner or ink.

15. A non-transitory computer readable medium embodying a program executable in a computing device for managing and monitoring a print, the program comprising:
a program code for receiving an electronic document for a print job, wherein the electronic document is received via a computer network;
a program code for determining a plurality of characteristics for the print job;
a program code for detecting one or more conditions of one or more network-connected printers, wherein the one or more conditions are detected by monitoring the printers;
a program code for generating a recommendation to utilize one of the printers based on the detected conditions and the determined characteristics;
a program code for selecting one of the printers based on the recommendation; and
a program code for transmitting the print job to the selected printer for printing the electronic document.
